(19) United States
(12) Patent Application Publication
(10) Pub. No.: US 2026/0009479 A1
(43) Pub. Date: Jan. 8, 2026

(54) Fire Hose with Partial-Length Third Jacket

(71) Applicant: Mercedes Textiles Ltd., St. Laurent (CA)

(72) Inventor: Duane Leonhardt, St. Laurent (CA)

(21) Appl. No.: 19/170,355

(22) Filed: Apr. 4, 2025

Related U.S. Application Data
(60) Provisional application No. 63/667,770, filed on Jul. 4, 2024.

(51) Int. Cl. F16L 11/12; A62C 31/02

(52) U.S. Cl. CPC F16L 11/12; A62C 31/02

(57) ABSTRACT

A fire hose for firefighting fire hose comprises a polymer tube defining a waterway, a first, inner jacket surrounding the tube to reinforce the tube, and a second, outer jacket surrounding the first, inner jacket. The second, outer jacket is made of an abrasion-resistant material. A partial-length third jacket is disposed between the first, inner jacket and the second, outer jacket. The length of the partial-length third jacket may be 2 to 8 feet. The partial-length third jacket reduces the bend radius and thus inhibits kinking of the fire hose, particularly at low pressure. The fire hose is thus particularly well suited to be used as an attack hose using a nozzle-forward technique.

### RELATED APPLICATION DATA

This application claims priority benefit to U.S. provisional application Ser. No. 63/667,770, filed Jul. 4, 2024, the disclosure of which is incorporated by reference herein.

### TECHNICAL FIELD

The present disclosure relates to fire hoses for firefighting.

### BACKGROUND

Many different types of fire hoses are known in the firefighting industry. One type of fire hose is a double-jacketed fire hose. This fire hose has two jackets (i.e. an inner jacket and an outer jacket) as well as an inner tube (“waterway” or “lining”) for carrying water or other firefighting fluid. The inner and outer jackets thus form a two-layered outer sheath that envelops and protects the inner tube (waterway) from wear. The inner tube may be may of any suitable polymer or elastomer. The inner and outer jackets may be made of any suitable abrasion-resistant woven fabrics.

A new firefighting technique known as nozzle forward is increasingly popular. Developed by Seattle-based firefighter Aaron Fields, the nozzle forward technique is described at the following website: https://nozzleforward.com/. One problem that arises when firefighters wish to employ the nozzle-forward technique is that the fire hose may be prone to bending too much or to kinking, especially at low water pressure. A technical solution to this problem would be highly desirable.

### SUMMARY

In general, the specification discloses a novel fire hose having a first, inner jacket, a second, outer jacket and a partial-length third jacket extending two to eight feet from the outlet of the fire hose to make that portion of the fire hose more rigid. This third jacket inhibits bending or kinking of the fire hose, thereby making it more suitable for using a nozzle-forward technique.

One inventive aspect of the disclosure is a fire hose comprising a polymer tube defining a waterway. The fire hose includes a first, inner jacket surrounding the tube to reinforce the tube, a second, outer jacket surrounding the first, inner jacket. The second, outer jacket is made of an abrasion-resistant material. The fire hose further includes a partial-length third jacket disposed between the first, inner jacket and the second, outer jacket.

Another inventive aspect of the disclosure is a method of fighting a fire using a nozzle-forward technique. The method entails steps or acts of providing a fire hose having a polymer tube defining a waterway and a first, inner jacket surrounding the tube to reinforce the tube. The fire hose also has a second, outer jacket surrounding the first, inner jacket, in which the second, outer jacket is made of an abrasion-resistant material. The fire hose includes a partial-length third jacket disposed between the first, inner jacket and the second, outer jacket. The method further entails holding the fire hose using the nozzle-forward technique. The fire hose is less prone to kinking due to the partial-length third jacket.

This summary is not an extensive overview of all contemplated embodiments and is not intended to identify key or critical aspects or features of any embodiments or to delineate any embodiments. Other aspects and features will become apparent to those of ordinary skill in the art upon review of the following description in view of the accompanying figures.

### BRIEF DESCRIPTION OF THE DRAWINGS

Example embodiments will be described in more detail referring to the following figures, in which:

FIG. 1 is a side view of a fire hose in accordance with an embodiment of the present invention;

FIG. 2 is a partial cutaway view of the hose of FIG. 1 showing the tube, first, second and third jackets.

FIG. 3 is a fire hose having a partial-length third jacket of a different length compared to the one shown in FIG. 1.

FIG. 4 is an end view of the fire hose.

It will be noted that throughout the appended figures, like features are identified by like reference numerals.

### DETAILED DESCRIPTION

Disclosed herein is a double-jacketed fire hose having a third intermediate jacket (or third layer) that extends from an outlet of the fire hose over only a short portion or segment of the hose. This third jacket reduces the bend radius of the fire hose and inhibits unwanted kinking of the fire hose. This novel fire hose is particularly well suited for using a nozzle-forward technique. In a nozzle-forward technique, the firefighter's hands may generally be holding only the fire hose and not the nozzle itself. Increased stiffness or rigidity of the downstream portion of the fire hose is thus beneficial to provide better control of the fire hose by the firefighter who is holding only the fire hose and not the nozzle itself.

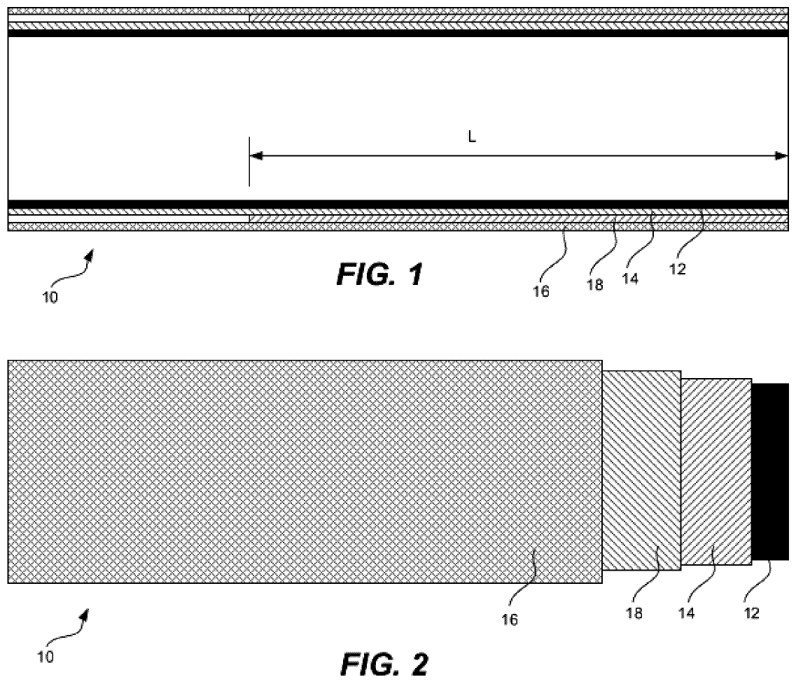

In the embodiment depicted by way of example in FIGS. 1 and 2, a fire hose denoted generally by reference numeral 10 comprises a polymer tube 12 defining a waterway and a first, inner jacket 14 surrounding the tube 12 to reinforce the tube. The fire hose 10 comprises a second, outer jacket 16 surrounding the first, inner jacket 14.

The second, outer jacket is made of an abrasion-resistant material. The fire hose 10 also comprises a partial-length third jacket 18 disposed between the first, inner jacket 14 and the second, outer jacket 16. It will be appreciated that the drawings are not to scale. Thus, the third jacket could extend further than what is shown in these drawings.

In one embodiment, as depicted in FIGS. 1 and 2, the partial-length third jacket 18 has a length of 2 to 8 feet from an outlet of the fire hose. The outlet of the fire hose is the downstream end of the first hose that connects to a nozzle. The inlet or upstream end of the fire hose connects to a water source like a fire hydrant or firetruck. The length of the fire hose is the distance measured along the hose from the inlet to the outlet. The first jacket and the second jacket, in these embodiments, have lengths that are equal to the length of the fire hose. The partial-length third layer in these embodiments has a shortened length that is significantly less than the length of the fire hose. In one specific embodiment, depicted in FIG. 3, the length of the third jacket 18 is 4 feet. The third jacket 18 has the effect of reducing a bend radius of the fire hose 10 over the length of the partial-length third jacket 18 to thereby inhibit excessive bending or hose kinking at low pressure. The fire hose is intended to be used as an attack hose so that a firefighter can use the nozzle-forward technique although the same concept could, at least in theory, be applied to any other hose where bend resistance or kink resistance is desired, including a supply hose or relay hose. However, the primary utility of the fire hose 10 is as an attack hose for using the nozzle-forward technique.

In one embodiment, the second, outer jacket 16 and the third jacket 18 are made of the same material. The material may be polyester. Alternatively, the jackets may be made of different materials. The jackets may be made of fabric containing cotton or nylon. The jacket may include fibers made of aramid, glass, silica, alumina, polybenzimidazole or polyacrylonitrile. The fabric may also be coated with silicone. In one embodiment, the third jacket (i.e. the short interim jacket) could be an elastomeric tube. The third jacket could be made of vulcanized rubber, synthetic rubber, plastic, or thermoplastic.

In one embodiment, the tube 12 is made of polyurethane (e.g. thermoplastic polyurethane), while the first, inner jacket 14 is made of filament polyester warp and weft yarn, the second jacket is made of spun polyester 16, and the third jacket is made of woven polyester 18. The tube may alternatively be made of other materials such as, for example, PVC/nitrile butadiene, styrene butadiene, chloroprene, or ethylene propylene.

In these embodiments, the first, inner jacket is fused to the tube. For example, an extrusion—through—the weave technique may be used to fuse the first, inner jacket to the tube. The fire hose may be manufactured using other techniques. In one embodiment, the first, second and third jackets are all coupled (at their respective outlet ends) to a coupling bowl. Alternatively, the third jacket can be affixed to the second jacket. In this alternative embodiment where the third jacket is affixed to the second jacket, the third jacket can be affixed only at the outlet end to the second jacket, i.e. a single circumferential connection. In a variant, the third jacket can be affixed at multiple locations along the partial length of the third jacket, i.e. having multiple circumferential connections. In another variant, the third jacket can be entirely affixed along the partial length of the third jacket.

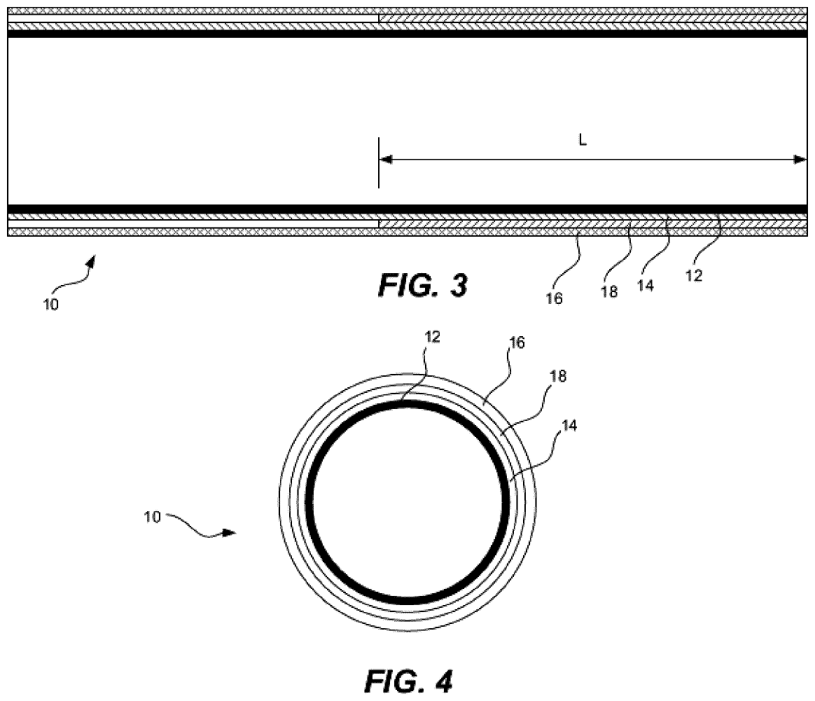

FIG. 4 is an end view of the fire hose 10 of either FIG. 1 or FIG. 3. In FIG. 4, the three jackets are visible around the tube 12, i.e. the first, inner jacket 14, the second, outer jacket 16 and the third partial-length jacket 18. The relative thicknesses of the tube, first, second and third jackets may be different from what is shown. In one implementation, the third jacket may be thinner than the second jacket. In another implementation, the third jacket may be thicker than the second jacket.

Another aspect of the disclosure is a method of fighting a fire using a nozzle-forward technique, the method comprising providing a fire hose having a polymer tube defining a waterway, a first, inner jacket surrounding the tube to reinforce the tube, a second, outer jacket surrounding the first, inner jacket, the second, outer jacket being made of an abrasion-resistant material, and a partial-length third jacket disposed between the first, inner jacket and the second, outer jacket. The method may be performed by holding the first hose using the nozzle-forward technique, whereby the fire hose is less prone to kinking due to the partial-length third jacket.

In one embodiment of the method, the partial-length third jacket has a length of 2 to 8 feet. In one specific embodiment of the method, the hose has a length of 4 feet. The method may be performed using a hose in which the second, outer jacket and the third jacket are made of the same material. The method may be performed with a hose in which the tube is made of polyurethane, the first, inner jacket is made of filament polyester warp and weft yarn, the second jacket is made of spun polyester, and the third jacket is made of woven polyester. The method may be performed using a hose in which the first, inner jacket is fused to the tube. The method may be performed using a hose in which the first, second and third jackets are all coupled to a coupling bowl.

The fire hose 10 confers numerous advantages over prior-art fire hoses. Although it would be easier and faster to manufacture a fire hose where the third, intermediate jacket is the complete length of the fire hose (i.e. equal in length to the tube and first and second jackets), the use of a partial-length third jacket saves a significant amount weight compared to having a complete third jacket. Weight savings is extremely important for a fire hose. Carrying a heavy fire hose slows the firefighter and tires him out. Also, heart attack is by far the highest killer of firefighters. A lighter fire hose is thus extremely important. Also, just as importantly, by having only the partial length for the third jacket, the fire hose is easier to pack because most of the fire hose is still just double jacket. Furthermore, with only a partial-length third jacket, the fire hose fits into a tighter folded space in a compartment of the fire truck.

For the purposes of interpreting this specification, when referring to elements of various embodiments of the present invention, the articles “a”, “an”, “the” and “said” are intended to mean that there are one or more of the elements. The terms “comprising”, “including”, “having”, “entailing” and “involving”, and verb tense variants thereof, are intended to be inclusive and open-ended by which it is meant that there may be additional elements other than the listed elements.

This invention has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

1. A fire hose comprising:
a polymer tube defining a waterway;
a first, inner jacket surrounding the tube to reinforce the tube;
a second, outer jacket surrounding the first, inner jacket, the second, outer jacket being made of an abrasion-resistant material; and
a partial-length third jacket disposed between the first, inner jacket and the second, outer jacket.

2. The fire hose of claim 1 wherein the partial-length third jacket has a length of 2 to 8 feet from an outlet of the fire hose.

3. The fire hose of claim 2 wherein the length is 4 feet.

4. The fire hose of claim 1 wherein the third jacket reduces a bend radius of the fire hose over the length of the partial-length third jacket to thereby inhibit hose kinking at low pressure.

5. The fire hose of claim 1 wherein the second, outer jacket and the third jacket are made of the same material.

6. The fire hose of claim 1 wherein the tube is made of polyurethane, wherein the first, inner jacket is made of filament polyester warp and weft yarn, wherein the second jacket is made of spun polyester, and the third jacket is made of woven polyester.

7. The fire hose of claim 1 wherein the fire hose is an attack hose.

8. The fire hose of claim 1 wherein the first, inner jacket is fused to the tube.

9. The fire hose of claim 1 wherein the first, second and third jackets are all coupled to a coupling bowl.

10. A method of fighting a fire using a nozzle-forward technique which a firefighter grips only the fire hose, the method comprising:
providing the fire hose having:
a polymer tube defining a waterway;
a first, inner jacket surrounding the tube to reinforce the tube;
a second, outer jacket surrounding the first, inner jacket, the second, outer jacket being made of an abrasion-resistant material; and
a partial-length third jacket disposed between the first, inner jacket and the second, outer jacket;
holding the fire hose using the nozzle-forward technique by gripping only the fire hose, whereby the fire hose is less prone to kinking due to the partial-length third jacket.

11. The method of claim 10 wherein the partial-length third jacket has a length of 2 to 8 feet.

12. The method of claim 10 wherein the length is 4 feet.

13. The method of claim 10 wherein the second, outer jacket and the third jacket are made of the same material.

14. The method of claim 10 wherein the tube is made of polyurethane, wherein the first, inner jacket is made of filament polyester warp and weft yarn, wherein the second jacket is made of spun polyester, and the third jacket is made of woven polyester.

15. The method of claim 10 wherein the first, inner jacket is fused to the tube.

16. The method of claim 10 wherein the first, second and third jackets are all coupled to a coupling bowl.
